(19) United States
(12) Patent Application Publication
(10) Pub. No.: US 2017/0219433 A1
(43) Pub. Date: Aug. 3, 2017

(54) SPECTROSCOPIC MEASUREMENT METHOD AND SPECTROSCOPIC MEASUREMENT DEVICE

(71) Applicant: Sumitomo Electric Industries, Ltd., Osaka-shi (JP)

(72) Inventors: Toshiaki Okuno, Yokohama-shi (JP); Tetsu Morishima, Yokohama-shi (JP); Miyoko Fujimoto, Yokohama-shi (JP)

(21) Appl. No.: 15/488,009

(22) Filed: Apr. 14, 2017

Related U.S. Application Data
(63) Continuation of application No. PCT/JP2015/076819, filed on Sep. 21, 2015.

(30) Foreign Application Priority Data
Oct. 14, 2014 (JP) 2014-209746

(51) Int. Cl. G01J 3/28; G01J 3/02; G01N 21/359

(52) U.S. Cl. CPC G01J 3/2823; G01N 21/359; G01J 3/0218; G01N 2201/12; G01J 2003/2826

(57) ABSTRACT

A spectrometric method includes illuminating a target object with measurement light from a light source; receiving with a plurality of two-dimensionally-arranged pixels transmitted light or diffused reflected light output from the target object as a result of being irradiated with the measurement light; acquiring spectral data of each of a plurality of unit regions including at least one unit region and a unit region adjacent to the one unit region on the target object; and calculating spectral data of the target object by averaging the spectral data of the plurality of unit regions. Furthermore, a spectrometric device captures an image of the same unit region of the target object a plurality of times (twice or more) and calculates the spectral data of the target object by integrating and averaging a plurality of times' worth of spectral data obtained at each of the image-captured unit regions of the target object.

### CROSS-REFERENCE TO RELATED APPLICATIONS

The present application is a continuation application of International Application No. PCT/JP2015/076819, filed Sept. 21, 2015, which claims priority to Japanese Patent Application No. 2014-209746, filed Oct. 14, 2014. The contents of these applications are incorporated herein by reference in their entirety.

### BACKGROUND OF THE INVENTION

Field of Invention

The present invention relates to spectrometric methods and spectrometric devices for performing analyses by acquiring spectral data of target objects to be measured.

Description of the Related Art

In a device that radiates measurement light onto a target object to be measured so as to acquire spectral data of the target object from a plurality of unit regions on the target object, spectral data obtained by averaging the spectral data of the plurality of unit regions is sometimes used (for example, see. JP 2012-173174A).

### SUMMARY OF INVENTION

An object is to provide a spectrometric method and a spectrometric device that enable a highly-accurate analysis.

In order to solve the problem, there is provided a spectrometric method including illuminating a target object to be measured with measurement light from a light source; receiving with a plurality of two-dimensionally-arranged pixels transmitted light or diffused reflected light output from the target object as a result of being irradiated with the measurement light; acquiring spectral data of each of a plurality of unit regions a plurality of times, the plurality of unit regions including at least one unit region and a unit region adjacent to the one unit region on the target object; and calculating spectral data of the target object by averaging the spectral data of the plurality of unit regions acquired the plurality of times.

As a first aspect of the spectrometric method according to the present invention, the plurality of two-dimensionally-arranged pixels may include pixels arranged in a first direction and pixels arranged in a second direction orthogonal to the first direction, and wavelength information may be allocated to each of the pixels arranged in the first direction and positional information of the target object may be allocated to each of the pixels arranged in the second direction so that spectral data of each of the unit regions disposed in the second direction on the target object may be acquired. As a second aspect of the spectrometric method according to the present invention, the spectral data of each of the plurality of unit regions may be acquired by causing at wavelength variable filter provided at a front stage of the plurality of two-dimensionally-arranged pixels to temporally change a transmission wavelength.

In either of the aspects, the measurement light preferably includes light n a wavelength range of 1650 nm to 1750 nm or 2100 nm to 2200 nm. Furthermore, the plurality of two-dimensionally-arranged pixels preferably include 40,000 or more pixels (for example, 200×200 pixels).

A spectrometric device according to present invention includes a light source that radiates measurement light onto a target object to be measured; image capturing means (hyperspectral camera) that acquires spectral data of each of a plurality of unit regions on the target object by receiving with a plurality of two-dimensionally-arranged pixels transmitted light or diffused reflected light output from the target object as a result of being irradiated with the measurement light from the light source; and spectrum calculating means (computer) that calculates spectral data of the target object based on the spectral data of each of the plurality of unit regions obtained in the image capturing means. The image capturing means acquires the spectral data of each of the plurality of unit regions a plurality of times. The spectrum calculating means calculates the spectral data. of the target object by averaging the spectral data acquired the plurality of times in at least one unit region and a unit region adjacent to the one unit region on the target object.

The spectrometric method and the spectrometric device according to the present invention achieve an unproved S/N ratio and enable a highly-accurate analysis.

### BRIEF DESCRIPTION OF DRAWINGS

FIG. 1 schematically illustrates an inspection device according to an embodiment of the present invention.

FIG. 2 schematically illustrates a hyperspectral image.

FIG. 3 is a graph illustrating the relationship between the number of unit regions to be averaged in a spatial direction and the S/N ratio.

FIG. 4 is a graph illustrating the relationship between the measurement time and the S/N ratio.

FIG. 5 is a graph illustrating effects of SNV (standard normal variate) transformation.

FIG. 6 is a graph illustrating the relationship between the wavelength and the S/N ratio with respect to the averaging number as a parameter.

FIG. 7 is a graph illustrating the relationship between the accuracy of a calibration curve and the average number of unit regions in the spatial direction with reference to an example of measurement of the moisture percentage of a sodium tartrate.

### DESCRIPTION OF EMBODIMENT

Specific examples of a spectrometric method and a spectrometric device according to an embodiment of the present invention will be described below with reference to the appended drawings. The present invention is not to be limited to these examples and is intended to include all modifications that are indicated by the scope of the claims and that are within the interpretation and the scope equivalent to the scope of the claims.

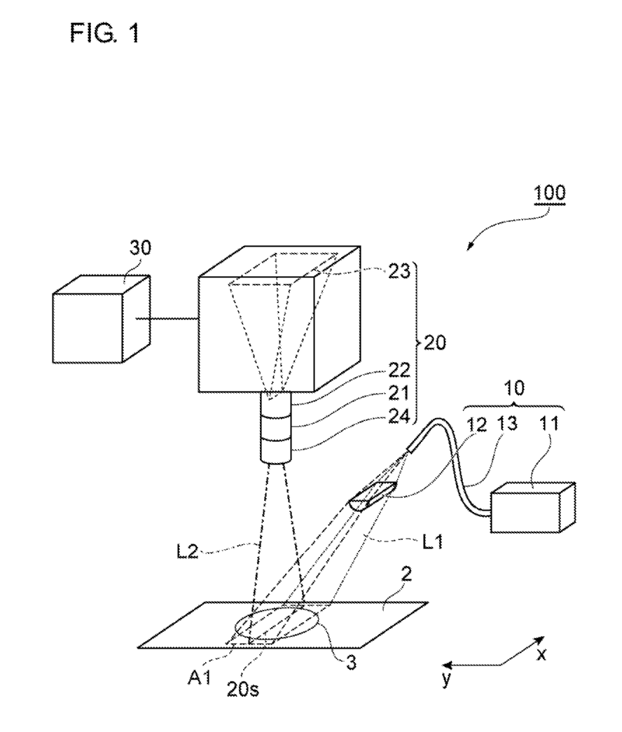

FIG. 1 schematically illustrates a spectrometric device 100 according to an embodiment of the present invention. The spectrometric device 100 evaluates, for example, the properties of a target object 3 to be measured placed on a measurement table 2. Although the target object 3 to be measured by the spectrometric device 100 is not particularly limited, it is preferable that the target object be a homogeneous object composed of a single material.

The spectrometric device 100 measures the spectrum of diffused reflected light obtained as a result of illuminating the target object 3 to be measured with measurement light, which is near-infrared light, and performs spectrometry on the target object 3 on the basis of the spectrum. For this purpose, the spectrometric device 100 includes a light source unit 10, a detecting unit 20 (image capturing means, hyperspectral camera), and an analyzing unit 30 (spectrum calculating means, computer). Although the following description of the embodiment relates to a case where near-infrared light is used for the spectrometry, light in another wavelength range may be used for the measurement. Moreover, the spectrum of transmitted light may be used in place of the spectrum of diffused reflected light.

The light source unit 10 radiates measurement light, which is near-infrared light, toward a predetermined irradiation region A1 on the measurement table 2. The wavelength range of the measurement light radiated from the light source unit 10 is appropriately selected in accordance with the target object 3. In detail, light in a wavelength range of 800 nm to 2500 nm is preferably used as the measurement light, and more specifically, light in a wavelength range of 1000 nm to 2300 nm is preferably used. The light source unit 10 described in this embodiment includes a light source 11 formed of a halogen lamp. In the case where the measurement light used is near-infrared light, it is preferable that the measurement be performed by using light in a wavelength range different from the absorption band of water. For example, it is preferable that light in a wavelength range of 1500 nm to 1800 nm (particularly, 1650 nm to 1750 nm) or 2100 nm to 2200 nm be used.

The irradiation region A1 is a part of the surface of the measurement table 2 on which the target object 3 is placed. The irradiation region A1 extends in the shape of a line in one direction (x-axis direction in FIG. 1) of the measurement table 2.

The light source unit 10 includes the light source 11, an irradiator 12, and an optical fiber 13 that connects the light source 11 and the irradiator 12. The light source 11 generates near-infrared light. The near-infrared light generated by the light source 11 is input to one of the end surfaces of the optical fiber 13. This near-infrared light is guided through a core region of the optical fiber 13 and is output to the irradiator 12 from the other end surface. The irradiator 12 radiates the near-infrared light output from the end surface of the optical fiber 13 onto the irradiation region A1 on which the target object 3 is placed. Because the irradiator 12 receives the near-infrared light output from the optical fiber 13 and outputs the near-infrared light in the shape of a one-dimensional line in correspondence with the irradiation region A1, a cylindrical lens is preferably used as the irradiator 12. Accordingly, near-infrared light L1 shaped into a line in the irradiator 12 is radiated onto the irradiation region A1 from the irradiator 12.

The near-infrared light L1 output from the light source unit 10 is diffused and reflected by the target object 3 placed on the irradiation region A1. A portion of the light is input as diffused reflected light L2 to the detecting unit 20.

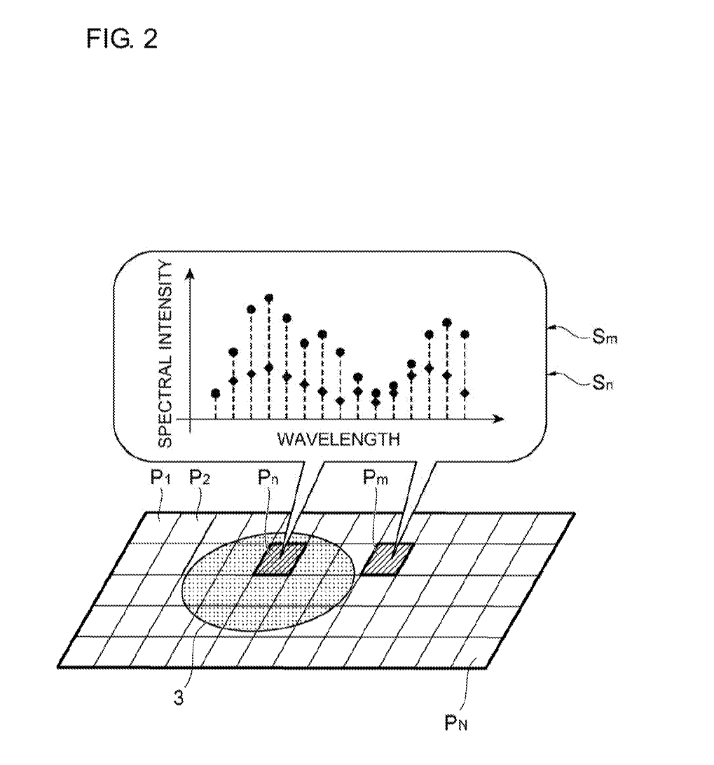

The detecting unit 20 functions as a hyperspectral sensor that acquires a hyperspectral image by using two-dimensionally-arranged sensors. FIG. 2 schematically illustrates the hyperspectral image, The hyperspectral image is constituted of N unit regions P₁ to P_{N}. FIG. 2 specifically shows two unit regions Pₙ and Pₘ as an example. Pₙ is a unit region on the target object obtained by image-capturing the target object 3, and Pₘ is a unit region on the background (e.g., the measurement table 2). The detecting unit 20 acquires the captured image of the background in addition to that of the target object 3.

The unit regions Pₙ and Pₘ respectively include spectral information Sₙ and spectral information Sₘ each of which is constituted of a plurality of pieces of intensity data. The intensity data indicates the spectral intensity at a specific wavelength (or waveband). In FIG. 2, 15 pieces of intensity data are kept as each of the spectral information Sₙ and the spectral information Sₘ and are shown in an overlapping state. Accordingly, a hyperspectral image H is characterized in having a plurality of pieces of intensity data for each of the unit regions constituting the image and is thus three-dimensionally-configured data having both a two-dimensional element as an image and an element as spectral data. In this embodiment, the hyperspectral image H refers to an image having intensity data in at least five wavebands per unit region.

Referring back to FIG. 1, the detecting unit 20 includes a camera lens 24, a slit 21, a spectroscope 22, and a light receiver 23. The detecting unit 20 has a field-of-view region 20s (image-capturing region) that extends in the same direction (x-axis direction) as the irradiation region A1. The field-of-view region 20s of the detecting unit 20 is a linear region included in the irradiation region A1 on the measurement table 2 and is where the diffused reflected light L2 passing through the slit 21 forms an image on the light receiver 23.

The slit 21 is an opening provided in a direction parallel to the extending direction (x-axis direction) of the irradiation region A1. The diffused reflected light L2 entering the slit 21 of the detecting unit 20 enters the spectroscope 22.

The spectroscope 22 separates the diffused reflected light L2 in a direction (y-axis direction) orthogonal to the longitudinal direction of the slit 21, that is, the extending direction of the irradiation region A1, The light separated by the spectroscope 22 is received by the light receiver 23.

The light receiver 23 includes a light-receiving surface having a plurality of two-dimensionally-arranged light-receiving elements, and each light-receiving element receives light. Thus, the light receiver 23 receives light at each wavelength of the diffused reflected light L2 reflected at each of the unit regions disposed in the extending direction (x-axis direction) of the irradiation region A1 on the measurement table 2. Each light-receiving element outputs a signal according to the intensity of the received light as information related to a single point on a two-dimensional plane constituted of positions and wavelengths. The signal output from each light-receiving element of the light receiver 23 is transmitted as spectral data of each unit region with respect to the hyperspectral image from the detecting unit 20 to the analyzing unit 30.

The analyzing unit 30 obtains the spectrum of the diffused reflected light L2 in accordance with the input signal and uses the obtained spectral data of each unit region so as to measure the target object 3. The analyzing unit 30 is configured as a computer including a CPU (central processing unit), a RAM (random access memory) and a ROM (read-only memory) that serve as main storage units, a communication module that performs communication with other units, such as the detecting unit, and a hardware unit, which may be an auxiliary storage unit, such as a hard disk. These components operate so that the analyzing unit 30 exhibits its function.

The spectrometric device 100 can acquire, in a single image-capturing process, a so-called one-dimensional spectral image with respect to each of the unit regions disposed in the extending direction (x-axis direction) of the irradiation region A1. Therefore, depending, on whether the measurement table 2 on which the target object 3 is placed is to be moved or a region to be image-captured by the spectrometric device 100 is to be moved, spectral data of the two-dimensionally-arranged unit regions with respect to the entire target object 3 can be acquired.

The spectrometric device 100 captures an image of the same unit region of the target object 3 a plurality of times (twice or more) and calculates spectral data of the target object 3 by integrating and averaging a plurality of times' worth of spectral data obtained at each of the image-captured unit regions of the target object 3. Alternatively, instead of fixing the unit regions to be averaged, a plurality of times' worth of appropriately-selected spectral data may be integrated and averaged.

In detail, in a case where the target object 3 is image-captured with the spectrometric device 100, it is assumed that spectral data of the target object 3 is acquired in M unit regions in a single image capturing process. When the measurement process is repeated N times by the spectrometric device 100, M×N pieces of spectral data are acquired. In spectral data obtained by averaging the M×N pieces of spectral data, the S/N ratio increases by √M times relative to spectral data obtained by image-capturing a single unit region. Accordingly, spectral data of the target object 3 is calculated not only by integrating and averaging neighboring spectral data, but also by averaging spectral data obtained by performing an image capturing process a plurality of times, so that the S/N ratio can be improved.

The spectral data of the target object 3 is preferably calculated by using spectral data of a plurality of two-dimensionally-arranged unit regions. In order to obtain highly-accurate spectral data, it is preferable to average spectral data of at least five unit regions obtained by integrating spectral data of four unit regions respectively adjacent to the upper, lower, left, and right sides of one unit region. If the target object is a homogeneous material, such as a liquid, it is preferable to average spectral data of unit regions more than or equal to the aforementioned five unit regions. In order to acquire highly-accurate spectral data related to the target object 3 faster, it is preferable that the number of pixels that are to acquire the spectral data of the target object 3 be 40,000 or more pixels (for example, 200×200 pixels). By averaging the obtained spectral data using image capturing means having a large number of pixels, the improvement of the S/N ratio becomes more notable, and the image capturing process for a desired number of spectral data for improving the S/N ratio can be performed faster.

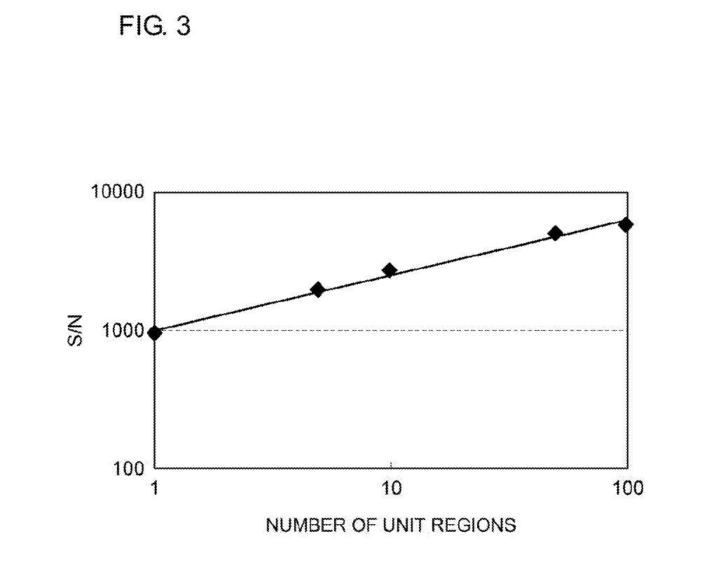

Next, the advantages of averaging the spectral data of the target object 3 in accordance with the above-described method will be described with reference to, for example, a practical example. FIG. 3 is a graph illustrating the relationship between the number of unit regions to be averaged among simultaneously image-captured unit regions, that is, the number of unit regions to be spatially averaged, and the S/N ratio. In this case, a standard white reflective plate is image-captured in place of the target object 3. The frame rate is set to 100 frames per second, the storage time per frame is set to 1 ms, and the image capturing time is set to 1 second. In other words, 100 pieces of spectral data are obtained per unit region. Furthermore, the wavelength range in which the spectral data is acquired (the wavelength range in which processing, such as averaging after the image capturing process, is performed) is 1580 nm to 1615 nm.

Although performing only temporal averaging with respect to spectral data obtained by image-capturing a single unit region results in an S/N ratio of 936, it is confirmed that the S/N ratio improves as the number of unit regions to be spatially averaged increases and that S/N>2000 is achieved by averaging five unit regions. When the S/N ratio exceeds 2000, quantitative measurement below 0.1% becomes possible. Furthermore it is confirmed that S/N>5000 is achieved by averaging 100 unit regions. When the S/N ratio exceeds 5000, there is a possibility that the quantitative accuracy improves by up to 0.02% so as to reach the accuracy level generally required in quantitative measurement, whereby this method may possibly be used in quantitative measurement. In other methods currently used in quantitative measurement, preprocessing often takes time. Moreover, since quantitative measurement is normally a destructive test, a quantitative measurement method using the spectrometric device 100 would be superior to the other methods.

Naturally, averaging spectral data of a plurality of neighboring unit regions, that is, performing spatial averaging, deteriorates the spatial resolution of the image. Specifically, the resolution deteriorates inversely proportional to the number of unit regions used for spatial averaging. However, if the target object is large relative to the pixels, is sufficiently observable at relatively low resolution, or is, for example, a liquid, it is conceivable that the measurement accuracy and the S/N ratio are often more important than the spatial resolution. Therefore, in such cases, the analysis method based on the spectrometric method and the spectrometric device according to this embodiment is preferably used.

As a result of further research, it is confirmed that the S/N ratio improves even by increasing the number of unit regions used for spatial averaging to 300. The improvement effects of the S/N ratio are confirmed in a case where the temporal average number is increased in a condition in which 300 unit regions are to be spatially averaged.

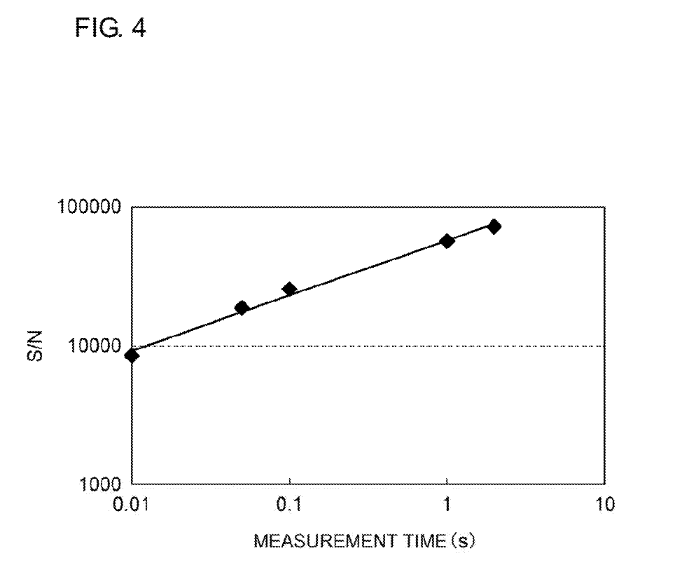

FIG. 4 is a graph illustrating the relationship between the measurement time and the S/N ratio. Similar to the evaluation shown in FIG. 3, the frame rate is set to 100 frames per second, the storage time per frame is set to 1 ms, and the wavelength range is set to 1585 nm to 1615 nm. Because the minimum value of 0.01 seconds on the abscissa axis specifically corresponds to one frame, this implies that averaging is not performed on the time axis. Although the S/N ratio is 8600 at 0.01 seconds in the condition in which 300 unit regions are to be spatially averaged, it is confirmed that the S/N ratio is improved to 18,000 by averaging five frames' (0.5 seconds') worth of spectral data. Furthermore, when averaging is performed up to 200 frames (2 seconds), the S/N ratio is improved proportional to [√measurement time], and an improvement effect of the S/N ratio as a result of performing averaging along the time axis is confirmed. When S/N>10,000, a spectrometric device has sufficient performance for performing a spectral analysis.

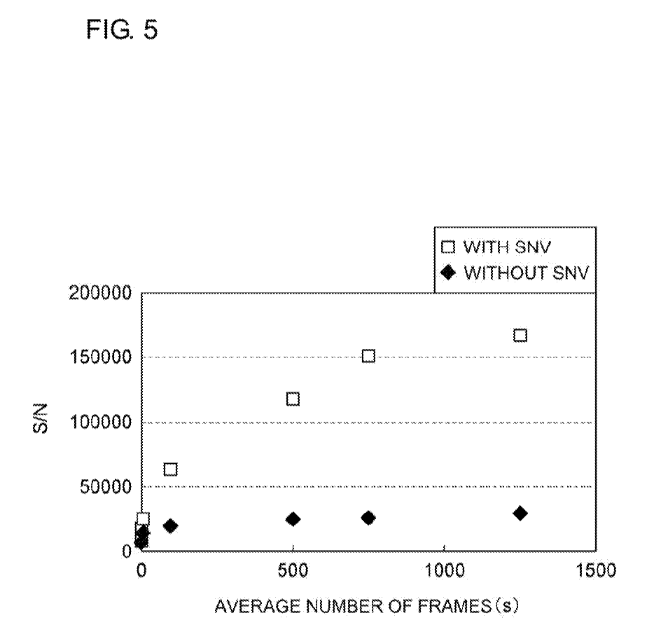

FIG. 5 is a graph illustrating the effects of SNV (standard normal variate) transformation. In order to check an influence on the S/N ratio caused by fluctuations of an external factor, such as output fluctuations of a light source, the effects of performing standard normal variate (SNV) transformation on an analyzed spectrum is confirmed. In a case where SNV transformation is not performed, saturation occurs immediately even if the number of frames to be averaged in the time-axis direction is increased. In contrast, by performing SNV transformation, it is confirmed that S/N>150,000. This implies that, in order to obtain a high S/N ratio, it is conceivable that it is effective to perform a spectral normalization process typified by, for example, SNV and multiplicative scattering correlation (MSC) in addition to increasing the number to be averaged in the spatial direction and the temporal direction.

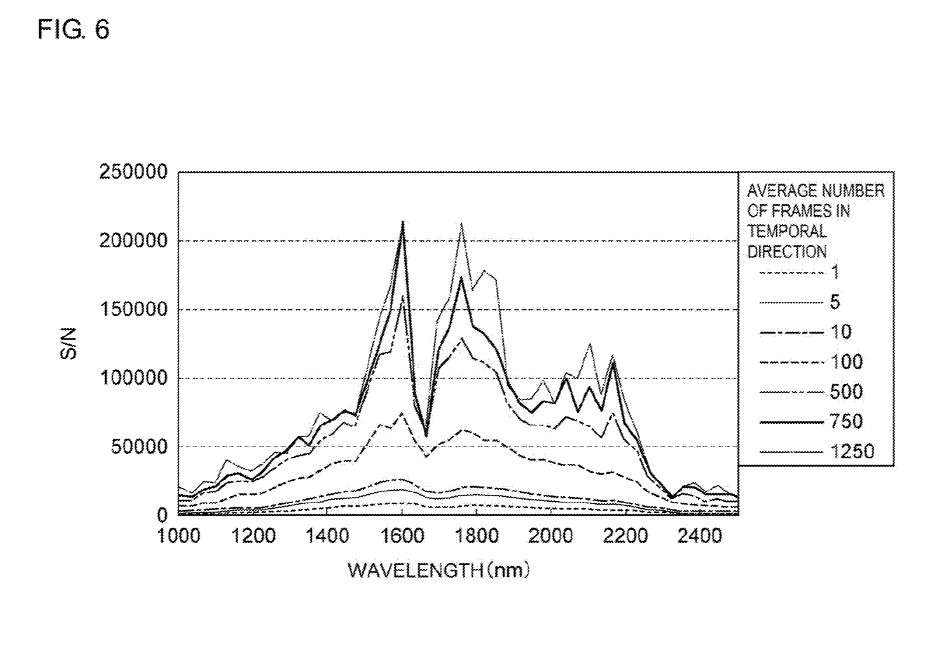

In this analysis, an InGaAs/GaAsSb quantum-well-type two-dimensional sensor is used as the detecting unit 20. This sensor has sensitivity to 1000 nm to 2350 nm and has a feature being able to substantially cover the near-infrared region with a single sensor. Although the wavelength range is limited in the above-described S/N evaluation result, if the aforementioned two-dimensional sensor is used in the configuration that captures a hyperspectral image, one dimension of the two-dimensional sensor is allocated to a wavelength component, as described above. FIG. 6 illustrates results obtained by plotting changes in the S/N ratio relative to the wavelength in a case where the number of unit regions to be spatially averaged is set to 300 and the averaging number in the temporal direction (average number of frames) is changed.

The changes in the S/N ratio shown in FIG. 6 also include the spectrum of the light source and the wavelength dependency of loss of the optical system. When image-capturing concreate target objects, the waveband required for the analysis varies from target object to target object. Therefore, it is necessary to ensure a required S/N ratio in a desired wavelength range. Based on the results in FIG. 6, it is confirmed that, by setting the number of unit regions to be averaged to 500 or more, S/N>50,000 is achieved even in the near-infrared region, particularly, in the wavelength range of 1700 nm to 2200 nm at the long wavelength side. Therefore, by simultaneously performing spatial averaging and temporal averaging, high-speed and highly-accurate spectrometric method and spectrometric device can be achieved.

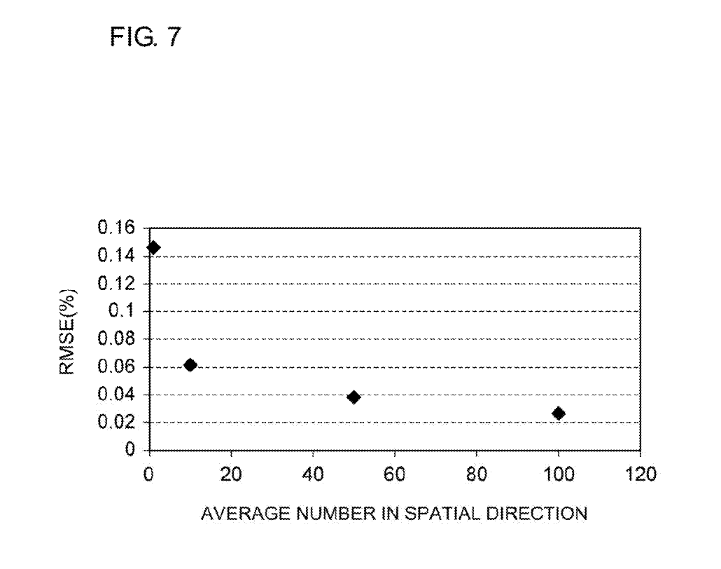

A quantitative example of the moisture percentage in a sodium tartrate will be described as an example in which a homogenous medium can be accurately measured by performing averaging in the spatial direction. By using a spectrometric device equipped with the InGaAs/GaAsSb quantum-well-type two-dimensional sensor used in the above-described evaluation, the absorbance spectra of a sodium tartrate (with a moisture percentage of 0 wt %) and a sodium tartrate dihydrate (with a moisture percentage of 15.66 wt %) are measured. An absorbance average spectrum is acquired by setting the frame rate to 200 frames per second and while changing the number of unit regions to be averaged in the spatial direction without performing temporal averaging of data. Then, by performing a PLS regression analysis of the absorbance data and the moisture percentage in a wavelength range of 1100 nm to 2200 nm, a calibration curve of the moisture percentage is created. The relationship between the accuracy of this calibration curve of the moisture percentage and the number of unit regions averaged in the spatial direction is examined. The results are shown in FIG. 7.

FIG. 7 is a graph illustrating the relationship between the accuracy of the calibration curve and the number of unit regions averaged in the spatial direction in case of an example of the measurement of the moisture percentage of the sodium tartrate. In FIG. 7, the accuracy of the calibration curve is evaluated based on a calibration-curve standard error (RMSE). As a result, it is confirmed that the RMSE decreases as the average number in the spatial direction increases. Accordingly, with the spectrometric method and the spectrometric device according to this embodiment, a homogeneous medium can be accurately calibrated without the measurement time increasing due to averaging in the spatial direction.

The configuration described in the spectrometric method and the spectrometric device according to the above embodiment acquires a so-called hyperspectral image by allocating wavelength information to each of pixels arranged in a first direction among a plurality of two-dimensionally-arranged pixels and allocating positional information of a target object to be measured to each of pixels arranged in a second direction orthogonal to the first direction so as to acquire spectral data of each of unit regions disposed in the second direction. Alternatively, another device configuration is also permissible. Specifically, a wavelength variable filter may be provided at the front stage of the two-dimensionally-arranged sensors, and the wavelength to be transmitted by the wavelength filter may be continuously changed, so that the spectrum is acquired at each sensor. With this configuration, spectral data of the target object may be acquired with respect to each unit region. By acquiring a hyperspectral image, spectral data related to specific unit regions can be acquired in real time, thereby allowing for even faster measurement.

Furthermore, although measurement using near-infrared light is described in the above embodiment, the embodiment may be applied to measurement using light in another wavelength range, such as the visible light range.

### INDUSTRIAL APPLICABILITY

For example, the present invention can be used for analyzing the chemical composition and for identifying foreign matter in resin and organic matter, such as food.

We claim:

1. A spectrometric method comprising:
illuminating a target object to be measured with measurement light from a light source;
receiving with a plurality of two-dimensionally-arranged pixels transmitted light or diffused reflected light output from the target object as a result of being irradiated with the measurement light;
acquiring spectral data of each of a plurality of unit regions a plurality of times, the plurality of unit regions including at least one unit region and a unit region adjacent to the one unit region on the target object; and
calculating spectral data of the target object by averaging the spectral data of the plurality of unit regions acquired the plurality of times.

2. The spectrometric method according to claim 1,
wherein the plurality of two-dimensionally-arranged pixels include pixels arranged in a first direction and pixels arranged in a second direction orthogonal to the first direction, and wherein wavelength information is allocated to each of the pixels arranged in the first direction and positional information of the target object is allocated to each of the pixels arranged in the second direction so that spectral data of each of the unit regions disposed in the second direction on the target object is acquired.

3. The spectrometric method according to claim 1,
wherein the spectral data of each of the plurality of unit regions is acquired by causing a wavelength variable filter provided at a front stage of the plurality of two-dimensionally-arranged pixels to temporally change a transmission wavelength.

4. The spectrometric method according to claim 1,
wherein the measurement light includes light in a wavelength range of 1650 nm to 1750 nm.

5. The spectrometric method according to claim 1,
wherein the measurement light includes light in a wavelength range of 2100 nm to 2200 nm.

6. The spectrometric method according to claim 1,
wherein the plurality of two-dimensionally-arranged pixels include 40,000 or more pixels.

7. A spectrometric device comprising:
a light source that radiates measurement light onto a target object to be measured;
image capturing means that acquires spectral data of each of a plurality of unit regions on the target object by receiving with a plurality of two-dimensionally-arranged pixels transmitted light or diffused reflected light output from the target object as a result of being irradiated with the measurement light from the light source; and
spectrum calculating means that calculates spectral data of the target object based on the spectral data of each of the plurality of unit regions obtained in the image capturing means,
wherein the image capturing means acquires the spectral data of each of the plurality of unit regions a plurality of times, and
wherein the spectrum calculating means calculates the spectral data of the target object by averaging the spectral data acquired the plurality of times in at least one unit region and a unit region adjacent to the one unit region on the target object.

8. The spectrometric device according to claim 7,
wherein the plurality of two-dimensionally-arranged pixels include pixels arranged in a first direction and pixels arranged in a second direction orthogonal to the first direction, and wherein wavelength information is allocated to each of the pixels arranged in the first direction and positional information of the target object is allocated to each of the pixels arranged in the second direction so that spectral data of each of the unit regions disposed in the second direction on the target object is acquired.

9. The spectrometric device according to claim 7,
wherein the measurement light includes light in a wavelength range of 1650 nm to 1750 nm.

10. The spectrometric device according to claim 7,
wherein the measurement light includes light in a wavelength range of 2100 nm 2200 nm.

11. The spectrometric device according to claim 7,
wherein the image capturing means is constituted of 40,000 or more pixels.

12. The spectrometric device according to claim 7,
wherein the image capturing means acquires, in the plurality of pixels, the spectral data of each of the plurality of unit regions on the target object by causing a wavelength variable filter provided at a front stage of the plurality of pixels to temporally change a transmission wavelength.
